(19) United States
(12) Patent Application Publication
(10) Pub. No.: US 2026/0330795 A1
(43) Pub. Date: Oct. 22, 2026

(54) PERFORMING ZOOM OPERATION ON COMPUTING DEVICE WITH CONVOLUTIONAL NEURAL NETWORK LAYERS

(71) Applicant: QUALCOMM Incorporated, San Diego, CA (US)

(72) Inventors: Nan ZHANG, Beijing (CN); Wenhao ZHANG, Beijing (CN); Wanjun LI, Shen Zhen (CN)

(21) Appl. No.: 19/486,326

(22) PCT Filed: Jun. 28, 2023
(86) PCT No.: PCT/CN2023/103111

§ 371 Date: Nov. 20, 2025

(51) Int. Cl. G06V 10/25; G06T 13/20; G06V 10/82

(52) U.S. Cl. CPC G06V 10/25; G06T 13/20; G06V 10/82

(57) ABSTRACT

Systems and methods for performing a zoom operation on a display of a computing device include identifying a region of interest (ROI) of an image presented on a computing device display based on a receive zoom user input, determining a scaling ratio for a final zoomed presentation of the ROI, selecting two or more convolutional neural network (CNN) layers from among a plurality of CNN layers each including a scaling ratio that is less than the scaling ratio for the final zoomed presentation of the ROI, generating an intermediate image from each of the selected CNN layers including a sequence of intermediate size image frames of the ROI, and rendering an animation of changes in a displayed size of the ROI using the sequence of intermediate size image frames of the ROI.

### BACKGROUND

Computing devices, such as smartphones, can utilize Artificial Intelligence (AI) for image processing using a dedicated AI processor or AI accelerator that is designed to run machine learning algorithms efficiently. The AI processor/accelerator also may execute convolutional neural networks (CNNs) as part of a CNN-based AI image processing system. CNNs are well suited for various image processing tasks such as image recognition, object detection, image resizing and image segmentation. While CNNs can be used to enlarge images in support of image zooming operations, CNN processing for image magnification take time to complete, and thus would result in unsmooth zoom animations if used directly. CNN processing is also power hungry, consuming an inordinate amount of battery power to enlarge images. Consequently, in many computing devices, a run-time zoom or run-time magnify operation is only available within certain applications executing on the computing device.

### SUMMARY

Various aspects include methods of performing a zoom operation on a computing device. Various aspects may include identifying a region of interest (ROI) of an image presented on a display of the computing device based on a zoom user input received by the computing device, determining a scaling ratio for a final zoomed presentation of the ROI, selecting two or more convolutional neural network (CNN) layers from among a plurality of CNN layers in which each CNN layer includes a scaling ratio that is less than the scaling ratio for the final zoomed presentation of the ROI, generating an intermediate image from each of the selected CNN layers in which the ROI in each image has dimensions smaller than dimensions of the final zoomed presentation of the ROI and greater than dimensions of the ROI, and rendering an animation of changes in a displayed size of the ROI using the sequence of intermediate size image frames of the ROI.

In some aspects, at least one of the selected CNN layers may include a non-integer scaling ratio. In some aspects, selecting two or more CNN layers from among the plurality of CNN layers may include selecting a quantity of the plurality of CNN layers based on an application requirement of an application executing in the computing device that provided the image. In some aspects, selecting two or more CNN layers from among the plurality of CNN layers may include selecting a quantity of the plurality of CNN layers based on an available quantity of memory of the computing device. Some aspects may include generating the plurality of CNN layers based on animation requirements of an image-providing application executing in the computing device. In some aspects, at least one of the generated plurality of CNN layers may include a non-integer scaling ratio.

Further aspects may include a computing device having a processing system configured with processor-executable instructions to perform various operations corresponding to the methods discussed above. Further aspects may include a non-transitory processor-readable storage medium having stored thereon processor-executable instructions configured to cause a processing system to perform various operations corresponding to the method operations discussed above. Further aspects may include a computing device having various means for performing functions corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a conceptual diagram illustrating aspects of a method 100 for performing a zoom operation on a computing device in accordance with various embodiments.

FIG. 1B is a conceptual diagram illustrating aspects of a method 150 for performing a zoom operation on a computing device in accordance with various embodiments.

FIGS. 2A and 2B illustrate an example neural network suitable for implementation in a computing device in accordance with various embodiments.

FIGS. 3A and 3B illustrate example functionality components that may be included in a convolutional neural network, which may be implemented in a computing device that is configured to implement a generalized framework for continual learning in accordance with various embodiments.

FIG. 4 is a component block diagram illustrating an example computing system implemented as a system in a package (SIP) suitable for implementing various embodiments.

FIG. 5A illustrates a method of performing a zoom operation on a computing device according to various embodiments

FIG. 5B illustrates operations that may be performed as part of the method of performing a zoom operation on a computing device according to various embodiments.

FIG. 6 is a component block diagram illustrating an example computing device suitable for use with various embodiments.

FIG. 7 is a component block diagram illustrating an example wireless communication device suitable for use with various embodiments.

FIG. 8 illustrates an example wearable computing device in the form of a smart watch suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and computing devices configured to implement the methods, for performing a zoom operation on an image or text on a display of a computing device in response to a user input for zooming the image or text. Various embodiments may include responding to a user input for a zoom operation (a “zoom user input”) by identifying a region of interest (ROI) of the image presented on the display of the computing device, and determining a scaling ratio for a final zoomed presentation of the ROI. The zoom operation may include selecting two or more convolutional neural network (CNN) layers from among a plurality of CNN layers, in which each CNN layer includes a scaling ratio that is less than the scaling ratio for the final zoomed presentation of the ROI. The zoom operation may further include using the selected CNN layers to generate intermediate images to provide a sequence of intermediate size image frames of the ROI each having dimensions smaller than dimensions of the final zoomed presentation of the ROI and greater than dimensions of the ROI. The sequence of intermediate size image frames of the ROI may then be used to render an animation of changes in a displayed size of the ROI using. In this manner, the computing device may be configured to implement dynamic dimension CNN layer inferencing. The enlarged image of the ROI at the final size or zooming factor may exhibit the fine resolution enabled through the use of CNN image processing.

The term “computing device” may be used herein to refer to any one or all of quantum computing devices, Edge computing devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processing system that can be configured to provide the functionality of various embodiments.

The term “system on chip” (SoC) is used herein to refer to a single integrated circuit (IC) chip that contains multiple resources or independent processing systems integrated on a single substrate. A single SoC may contain circuitry for digital, analog, mixed-signal, and radio-frequency functions. A single SoC also may include any number of general purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.), any one or more of which may function as a processing system. For example, an SoC may include an applications processor that operates as the SoC's main processor, central processing unit (CPU), microprocessor unit (MPU), arithmetic logic unit (ALU), etc. SoCs also may include software for controlling the integrated resources and processors, as well as for controlling peripheral devices.

The term “system in a package” (SIP) may be used herein to refer to a single module or package that contains multiple resources, computational units, cores, processors or processing systems on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard, in a single UE, or a single CPU device. The proximity of the SoCs facilitates high speed communications and the sharing of memory and resources.

The term “neural network” is used herein to refer to an interconnected group of processing nodes (e.g., neuron models, etc.) that collectively operate as a software application or process that controls a function of a computing device or generates a neural network inference. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and activation. The weight values may be determined during a training phase and iteratively updated as data flows through the neural network.

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers. Each layer in a neural network may have multiple inputs, and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer as well as multiple preceding layers.

The term “convolutional neural network” (CNN) is used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations generate the overall inference result of the neural network, such as a probability that an image contains a specific object (e.g., a person, cat, watch, edge, etc.) or information indicating that a proposed action should be taken.

The term “inference” may be used herein to refer to a process that is performed at runtime or during execution of the software application program corresponding to the neural network. Inference may include traversing the processing nodes in the neural network along a forward path to produce one or more values as an overall activation or overall “inference result.”

A computing device may include a display and graphics hardware or subsystem that utilizes machine learning techniques or Artificial Intelligence (AI) to enhance the performance and capabilities of the display and graphics processing. In a computing device that utilizes AI for image processing, the hardware may include a dedicated AI processing system or an AI accelerator that is designed to run machine learning algorithms more efficiently than the other processing systems. CNNs are one of the most commonly used AI methods for image processing.

In a computing device with a CNN-based AI image processing system, the CNNs may be run on the AI processing system or accelerator to analyze and process images that are to be displayed on the computing device's screen. Using AI image processing systems may improve the performance and efficiency of the computing device's display and graphics. AI image processing systems may also enhance a user's experience by supporting features such as improved image quality, real-time image enhancement, and more realistic virtual reality and augmented reality experiences. For example, an AI image processing systems may be used to enhance the realism of virtual and augmented reality experiences by improving the 3D graphics rendering and object tracking.

Bilinear and bicubic scalars are interpolation scaling techniques that may be used to resize or scale images. For example, bilinear or bicubic scalars may be used to change the size of an image by either increasing or decreasing the number of pixels it contains. Bilinear scaling may include using linear interpolation to determine the value of new pixels based on the values of nearby pixels in the original image. Bilinear scaling is particularly useful when the original image is smooth and does not contain many fine details. Bilinear scaling may cause loss of detail and blurring when used to magnify images with high levels of detail or texture. Bicubic scaling is a more complex technique that uses cubic interpolation to determine the values of new pixels based on the values of nearby pixels in the original image. Bicubic scaling may produce better results than bilinear scaling, particularly when scaling up images, with a wide range of image types, including those with high levels of detail or texture. Bicubic scaling may be slower or more processor-intensive than bilinear scaling. Both bilinear and bicubic scaling techniques may be used for image zooming, upscaling and downscaling.

AI super resolution is a technique that may be used to increase the resolution of an image or video. AI super resolution is commonly used in image and video processing tasks to improve the visual quality of the image or video. AI super resolution may be implemented by CNNs that take a low-resolution image as input and generate a high-resolution version of the image as output. AI super resolution may be used to enhance the visual quality of an image and/or video, and may be used for image zooming and upscaling. AI super resolution may be slower than bilinear and bicubic scaling, but generally produces a much higher image quality.

Some applications that execute on computing devices, and in particular on mobile computing devices (e.g., smart phones), such as map applications and some web browser applications, provide run time zoom or run time magnify functions for content generated by the application. For example, some map applications enable zooming in on map content within the map application. Such applications support the ability to zoom into content within the application in response to a user input to a touchscreen device or trackpad device (a “zoom user input”). For example, a zoom user input may include increasing a distance between two fingers in contact with a touchscreen (sometimes called a “reverse pinch” or “pinch out” gesture), a double-tap and drag gesture, or another suitable user input.

However, computing devices typically do not provide run time zoom functions generally outside of such applications, in part because neither bilinear/bicubic image scaling nor AI (CNN) based super resolution is well-suited to the task. Bilinear or bicubic image scaling typically does not provide sufficient content details, and AI (CNN) based super resolution does not provide smooth animations, and further consumes battery power at an undesired rate.

For example, a CNN model may execute or generate every frame (e.g., either in a graphics processing unit (GPU) or digital signal processor (DSP)) to provide CNN super resolution-based hybrid scaling/zooming animations. A typical hybrid CNN super resolution function causes significant power consumption and may struggle to provide smooth animations (e.g., without visible frame drops), particularly for advanced display screens that provide up to 120 Hz or 144 Hz display rates.

A typical “super zoom” pipeline uses a fixed upscale ratio, usually in a range from 1 to 5, that provides a balance between visual quality of upscaled images and power consumption. CNN models, such as may be implemented in a variety of computing devices, may be quantized and pre-compiled for use in various hardware (e.g., digital signal processors) and/or runtime software/hardware contexts. During a process of quantization and runtime optimization, CNN model layer weights, such as size, dimension, height, width, etc., must be held fixed and constant. However, CNN models with a fixed upscale ratio are limited in their efficiency and performance in performing image processing tasks such as image upscaling.

Various embodiments include methods and processing systems configured to perform the methods of performing a zoom operation on a computing device by implementing one or more CNN models with multiple different dynamic dimension CNN layers, with each layer appropriate for a particular different scaling factor or ratio. In some embodiments, a processing system of the computing device may identify an ROI of an image presented on a display of the computing device in response to receiving a zoom user input by the computing device, such as a “pinch out” gesture in the form of two fingertips touching a touch-sensitive display (i.e., “touchscreen”). In some embodiments, the processing system may determine a scaling ratio for a final zoomed presentation of the ROI based on various factors, such as the size of the ROI, the size of the display, and the like.

In various embodiments, the processing system may employ or apply a “multi-head” or “multi-layer” CNN in which each layer is trained to a different scaling ratio. Using such a multi-layer CNN approach enables the processing system to dynamically vary scaling ratios used to upscale the ROI responsive to the user input. In some embodiments, the processing system may select two or more CNN layers from among a plurality of CNN layers, in which each CNN layer includes a scaling ratio that is less than the scaling ratio for the final zoomed presentation of the ROI. The processing system may use each of the selected CNN layers to generate an intermediate image, to produce or generate a sequence of intermediate size image frames of the ROI in which each intermediate image has dimensions smaller than dimensions of the final zoomed presentation of the ROI and greater than dimensions of the ROI. The processing system may render an animation of changes in a displayed size of the ROI using the sequence of intermediate size image frames of the ROI. In some embodiments, at least one of the selected CNN layers includes a non-integer scaling ratio.

In some embodiments, the processing system may select a quantity of the plurality of CNN layers based on an application requirement of an application executing in the computing device that provided the image. For example, an application that generates an image including the ROI may provide to an image processor information indicating a requirement such as an image generation frequency or speed (e.g., a quantity of intermediate images to be generated for a zoom animation).

In some embodiments, the processing system may select a quantity of the plurality of CNN layers based on an available quantity of memory of the computing device. For example, a CNN layer may require a certain quantity of memory in which to execute and perform image scaling operations. Based on an available quantity of memory of the computing device, the processing system may allocate memory for use by one or more CNN layers, which may be less than a total amount of available computing device memory, and based on the quantity of allocated memory the computing device may select a quantity of the plurality of CNN layers.

In some embodiments, the processing system may generate the plurality of CNN layers during run-time, such as when an application that generates images that might be upscaled is launched, or when such an application is executing, or in response to the computing device receiving a zoom user input. In some embodiments, the processing system may generate the plurality of CNN layers based on animation requirements of an image-providing application executing in the computing device. For example, an application that generates an image including the ROI may provide to an image processor information indicating a requirement such as a minimum image resolution for intermediate images (e.g., images of various sizes between an original image size and a final scaled image size). In some embodiments, at least one of the generated CNN layers may include a non-integer scaling ratio.

Various embodiments improve the efficiency and performance of a processing system performing a zoom operation on an image element by increasing the efficiency of CNNs for performing image scaling operations such as image upscaling.

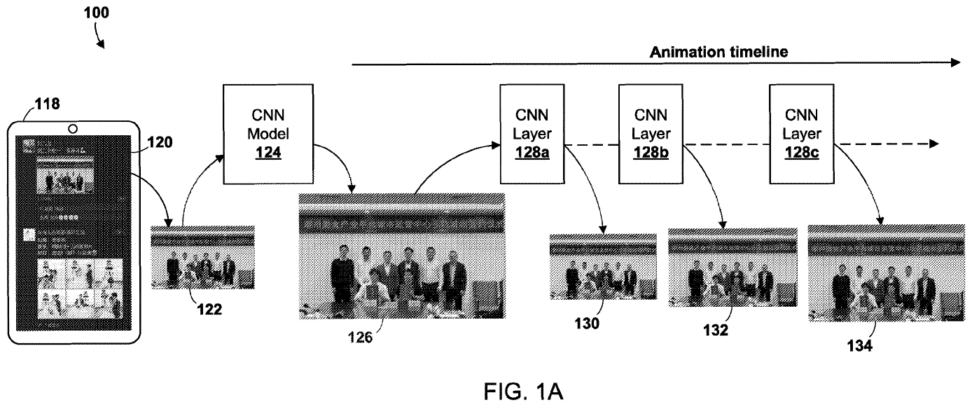

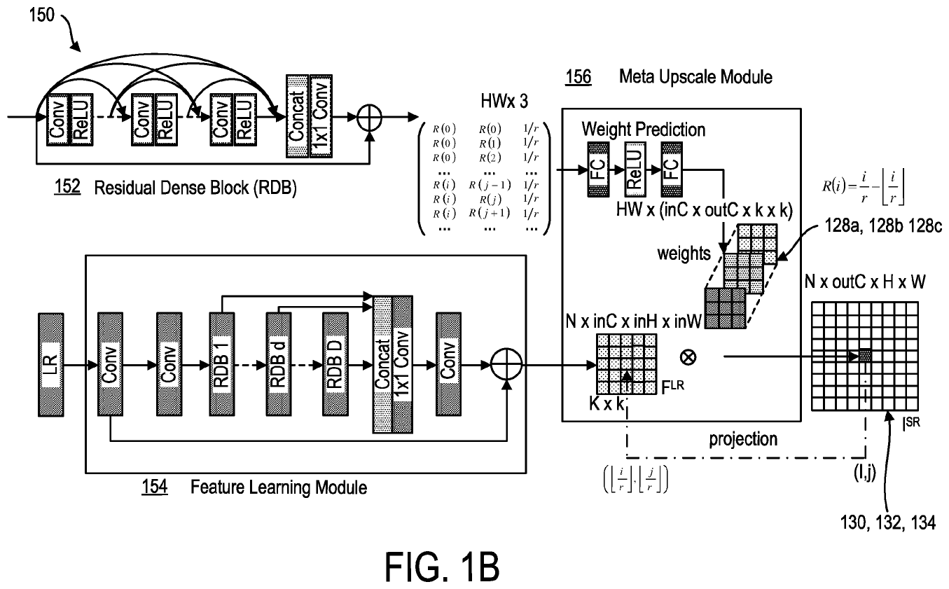

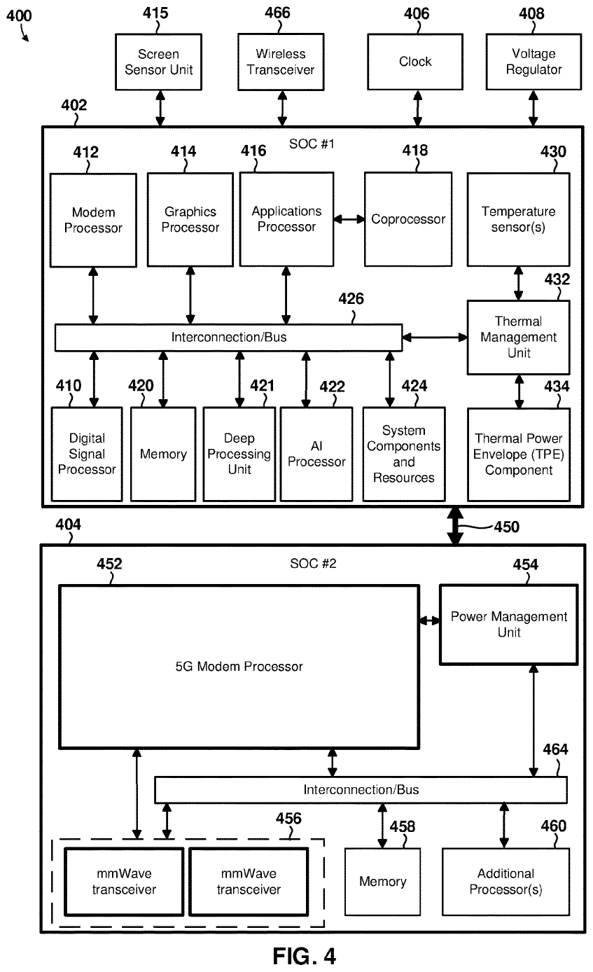

FIG. 1A is a conceptual diagram illustrating aspects of a method 100 for performing a zoom operation on a computing device in accordance with various embodiments. Means for performing operations of the method 100 may include one or more processing systems (e.g., processors 410, 412, 414, 416, 418, 421, 422, 452, 460 in FIG. 4) in a computing device (e.g., 118, 400).

The processing system may identify a region of interest (ROI) 122 of an image 120 presented on a display of the computing device 118 based on a zoom user input received by the computing device 118 (e.g., received by a touchscreen input device of the computing device 118). In some embodiments, the processing system may use a regional histogram analysis and/or image segmenting to identify the ROI 122.

The processing system may determine a scaling ratio for a final zoomed presentation of the ROI 126. In some embodiments, the processing system may determine the scaling ratio for the final zoomed image based on one or both of an image rendering requirement or an inference speed of a frame generation convolutional neural network (CNN) (“CNN model”) 124. In some embodiments, the processing system may determine (compute, identify) dimensions of the ROI 122 (such as a width and height). In some embodiments, the processing system may determine dimensions of a display of the computing device 118 (such as a width and height, a number of vertical pixels and horizontal pixels, or other suitable dimensions). In some embodiments, the processing system may determine a time and/or number of frames needed to expand the ROI 122 to fill the available display dimensions of the computing device 118.

In some embodiments, the processing system may identify dimensions of an image element within the ROI 122, such as a face, or any other suitable image element. For example, the processing system may identify a face within the ROI 122, and may determine a time and/or number of frames needed to expand the face to fill display dimensions of the computing device 118.

In some embodiments, the image rendering requirement may include a quantity of frames per second (FPS) generated by down-scaling the final zoomed presentation to the generated sequence of intermediate size image frames. In some embodiments, determining the scaling ratio for the final zoomed presentation of the ROI 122 may be further based on dimensions of the ROI 122 and dimensions of the display of the computing device 118. In some embodiments, determining the scaling factor for the final zoomed presentation of the ROI 122 may be further based on dimensions of an image element within the ROI 122 and dimensions of the display of the computing device 118. In some embodiments, the processing system may determine the scaling factor for the final zoomed presentation in response to detecting and initiation of a user zoom input.

In some embodiments, the processing system may select CNN layers 128a, 128b, 128c from among a plurality of CNN layers. Each of the CNN layers 128a, 128b, 128c may include a scaling ratio that is less than the scaling ratio for the final zoomed presentation of the ROI 126. In some embodiments, at least one of the CNN layers 128a, 128b, 128c may include a non-integer scaling ratio (e.g., a scaling ratio of 1.2, 3.6, etc.). In some embodiments, each of the CNN layers 128a, 128b, 128c may be generated to provide a scaling ratio (which may be a non-integer scaling ratio) during a process of compilation and quantization of the CNN model 124. In some embodiments, the processing system quantization may use a scaling ratio (which may be represented as r) based on a range of ratios or a discrete ratio. For example, during a training process, the range of scaling ratios may be, for example, 1×-6×, and during a quantization process, the scaling ratio for each CNN layer (e.g., 128a, 128b, 128c) may be quantized to a value such as 1.2, 2.1, 3.6, or another suitable scaling ratio. In operation, based on the scaling ratio, each CNN layer may include different dimensions. In some embodiments, each CNN layer may include a tensor shape having multiple indices, such as (2130,5130)×(64,3,3,3), (1510,3625)×(64,3,3,3), or (710,1710)×(64,3,3,3). Each CNN layer may include different dimensional weights that are calculated during offline inferencing for the trained CNN model 124. In some embodiments, during run time, the processing system may select two or more CNN layers 128a, 128b, 128c from among a plurality of CNN layers based on a pipeline requirement scaling ratio (e.g., r). For example, based on a requested scaling ratio of 1.2, the processing system may select a CNN layer having dimensions (710,1710)×(64,3,3,3).

In some embodiments, the processing system may select a quantity of the plurality of CNN layers 128a, 128b, 128c based on an application requirement of an application executing in the computing device 118 that provided the image. For example, an application that generates an image including the ROI may provide to an image processor information indicating a requirement such as an image generation frequency or speed (e.g., a quantity of intermediate images to be generated for a zoom animation).

In some embodiments, the processing system may select a quantity of the plurality of CNN layers 128a, 128b, 128c based on an available quantity of memory of the computing device. For example, a CNN layer may require a certain quantity of memory in which to execute and perform image scaling operations. Based on an available quantity of memory of the computing device 118, the processing system may allocate memory for use by one or more CNN layers, which may be less than a total amount of available computing device memory, and based on the quantity of allocated memory the processing system may select a quantity of the plurality of CNN layers.

The processing system may use each of the selected CNN layers 128a, 128b, 128c to generate an intermediate image 130, 132, 134, to produce or generate a sequence of intermediate size image frames of the ROI 122 in which each intermediate image 130, 132, 134 has dimensions smaller than dimensions of the final zoomed presentation of the ROI 126 and greater than dimensions of the ROI 122. The processing system may render an animation of changes in a displayed size of the ROI using the sequence of intermediate size image frames 130, 132, 134 of the ROI.

FIG. 1B is a conceptual diagram illustrating aspects of a method 150 for performing a zoom operation on a computing device in accordance with various embodiments. Means for performing operations of the method 150 may include one or more processing systems (e.g., processors 410, 412, 414, 416, 418, 421, 422, 452, 460 in FIG. 4) in a computing device (e.g., 118, 400).

In some embodiments, the processing system may generate the plurality of CNN layers 128a, 128b, 128c during run-time, such as when an application that may generate an image that may be upscaled is launched, or when such an application is executing, or in response to the computing device receiving a zoom user input. In some embodiments, the processing system may generate the plurality of CNN layers 128a, 128b, 128c based on animation requirements of an image-providing application executing in the computing device. For example, an application that generates an image including the ROI may provide to an image processor information indicating a requirement such as a minimum image resolution for intermediate images (e.g., images of various sizes between an original image size and a final scaled image size). In some embodiments, at least one of the generated CNN layers may include a non-integer scaling ratio.

In some embodiments, the processing system may implement a residual dense network (RDN) 150. The RDN 150 may include a residual dense block (RDB) 152 and a feature learning model 154, such as a dense connective block. The RDB 152 may be configured to extract abundant local features via dense connected convolutional layers. The feature learning model 154 may be configured to generate shared feature maps for an arbitrary scale factor. The RDN 150 also may include a meta upscale module 156. The meta upscale module 156 may be configured to receive a sequence of coordinate-related and scale-related vectors as input to generate weights for one or more CNN layers 128a, 128b, 128c. The meta upscale module 156 also may be configured to apply the CNN layers 128a, 128b, 128c to generate the intermediate images 130, 132, 134.

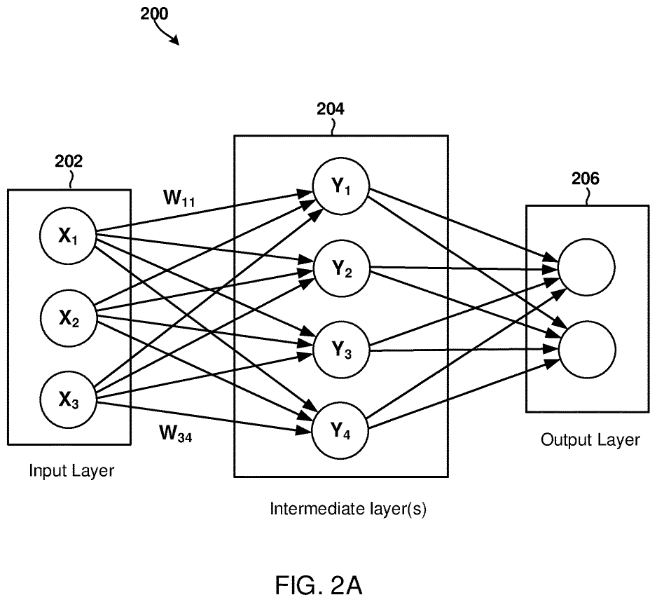

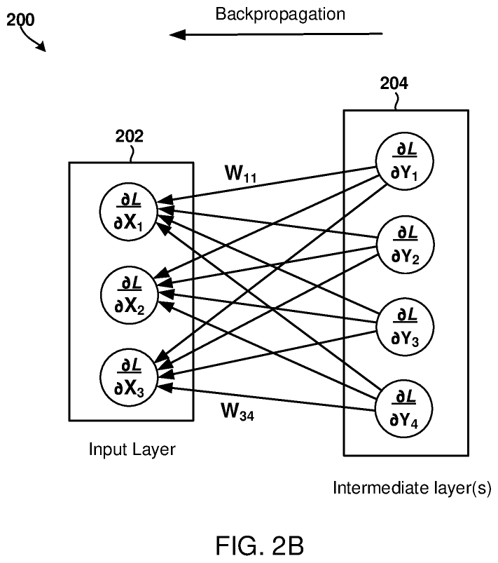

FIGS. 2A and 2B illustrate an example neural network 200 suitable for implementation in a computing device in accordance with various embodiments. With reference to FIGS. 1-2A, the neural network 200 may include an input layer 202, intermediate layer(s) 204, and an output layer 206. Each of the layers 202, 204, 206 may include one or more processing nodes that receive input values, perform computations based the input values, and propagate the result (activation) to the next layer.

In feed-forward neural networks, such as the neural network 200, all of the computations are performed as a sequence of operations on the outputs of a previous layer. The final set of operations generate the output of the neural network, such as a probability that an image contains a specific item (e.g., dog, cat, etc.) or information indicating that a proposed action should be taken. The final output of the neural network may correspond to a task that the neural network 200 may be performing, such as determining whether an image contains a specific item (e.g., dog, cat, etc.). Many neural networks 200 are stateless. The output for an input is always the same irrespective of the sequence of inputs previously processed by the neural network 200.

The neural network 200 may include fully-connected (FC) layers, which are also sometimes referred to as multi-layer perceptrons (MLPs). In a fully-connected layer, all outputs are connected to all inputs. Each processing node's activation is computed as a weighted sum of all the inputs received from the previous layer.

An example computation performed by the processing nodes and/or neural network 200 may be:

$${y}_{i} = f ( {\sum }_{i = 1}^{3} {W}_{i j} * {x}_{i} + b )$$

in which Wᵢⱼ are weights, xᵢ is the input to the layer, yⱼ is the output activation of the layer, f(⋅) is a non-linear function, and b is bias, which may vary with each node (e.g., bⱼ). As another example, the neural network 200 may be configured to receive pixels of an image (i.e., input values) in the first layer, and generate outputs indicating the presence of different low-level features (e.g., lines, edges, etc.) in the image. At a subsequent layer, these features may be combined to indicate the likely presence of higher-level features. For example, in training of a neural network for image upscaling, the output layer may generate a probability value that various lines, edges, colors, etc. are present in an enlarged (i.e., upscaled) version of the input image. In this manner the neural network can use the information available in a low-resolution small image to predict elements of the image that should be added to fill in details between pixels as the image is enlarged.

The neural network 200 may be trained to upscale images using a database of images of different sizes and resolutions. In this training process a small image may be provided as the input and a larger, higher resolution image of the same subject matter may be provides as the expected/desired output. Learning is accomplished by comparing the output generated by the neural network 200 to the expected/desired output and adjusting weights. The difference between the expected/desired output and the output generated by the neural network 200 is referred to as loss (L). The weights and biases in the neural network are then adjusted to bring the output image closer to the provided expected output image, thereby reducing the loss. During training, the weights (wᵢⱼ) may be updated using a hill-climbing optimization process called “gradient descent.” This gradient indicates how the weights should change in order to reduce loss (L). A multiple of the gradient of the loss relative to each weight, which may be the partial derivative of the loss

$$( e . g , \frac{\partial L}{\partial X 1} , \frac{\partial L}{\partial X 2} , \frac{\partial L}{\partial X 3} )$$

with respect to the weight, could be used to update the weights and biases. This learning process may be repeated for a large database of images.

FIG. 2B illustrates a manner of computing partial derivatives of a gradient through a process called backpropagation. With reference to FIGS. 1-2B, backpropagation may operate by passing values backwards through the network to compute how the loss is affected by each weight. The backpropagation computations may be similar to the computations used when traversing the neural network 200 in the forward direction (i.e., during inference). To improve performance, the loss (L) from multiple sets of input data (“a batch”) may be collected and used in a single pass of updating the weights. Many passes may be required to train the neural network 200 with weights suitable for use during inference (e.g., at runtime or during execution of a software application program).

The overall structure of the neural network 200, and operations of the processing nodes, do not change as the neural network learns this task. After such training is completed, the neural network 200 may process any image for upscaling using the determined weights and bias.

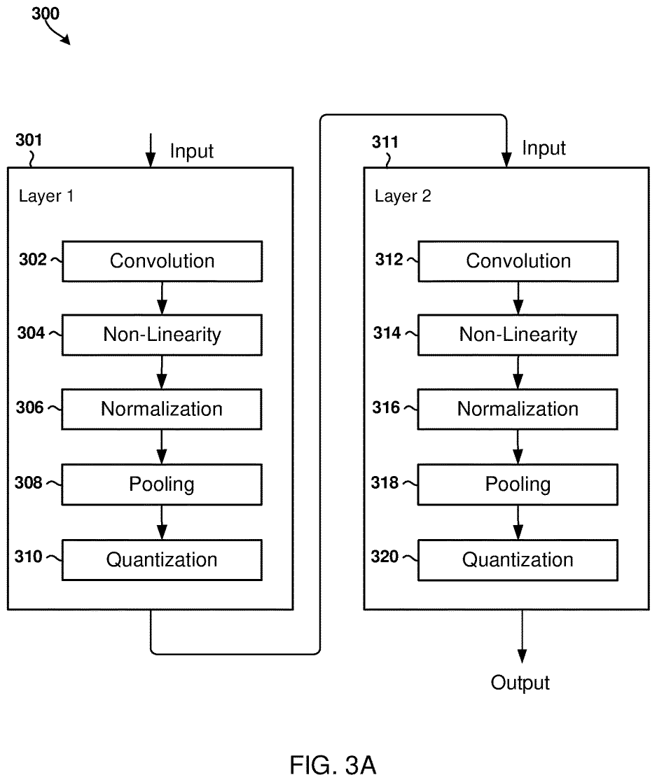

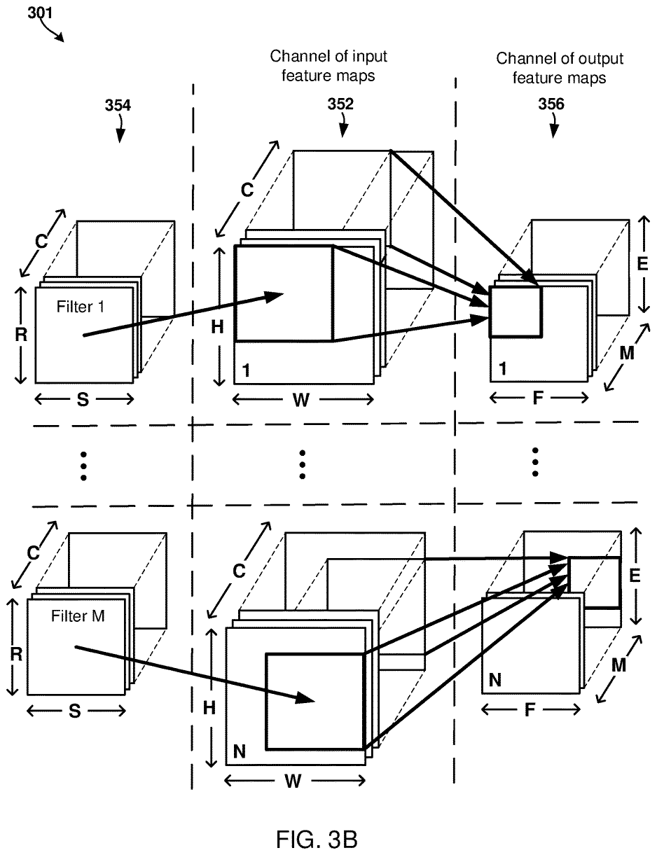

FIGS. 3A and 3B illustrate example functionality components that may be included in a convolutional neural network 300, which may be implemented in a processing system that is configured to implement a generalized framework for continual learning in accordance with various embodiments.

With reference to FIGS. 1-3B, the convolutional neural network 300 may include a first layer 301 and a second layer 311. Each layer 301, 311 may include one or more activation functions. In the example illustrated in FIG. 3A, each layer 301, 311 includes convolution functionality component 302, 312, a non-linearity functionality component 304, 314, a normalization functionality component 306, 316, a pooling functionality component 308, 318, and a quantization functionality component 310, 320. It should be understood that, in various embodiments, the functionality components 302-310 or 312-320 may be implemented as part of a neural network layer, or outside the neural network layer. It should also be understood that the illustrated order of operations in FIG. 3A is merely an example and not intended to limit various embodiments to any given operation order. In various embodiments, the order and/or inclusion of the operations of functionality components 302-310 or 312-320 may change in any given layer. For example, normalization operations by the normalization functionality component 306, 316 may come after convolution by the convolution functionality component 302, 312 and before non-linearity operations by the non-linearity functionality component 304, 314.

The convolution functionality component 302, 312 may be an activation function for its respective layer 301, 311. The convolution functionality component 302, 312 may be configured to generate a matrix of output activations called a feature map. The feature maps generated in each successive layer 301, 311 typically include values that represent successively higher-level abstractions of input data (e.g., line, shape, object, etc.).

The non-linearity functionality component 304, 314 may be configured to introduce nonlinearity into the output activation of its layer 301, 311. In various embodiments, this may be accomplished via a sigmoid function, a hyperbolic tangent function, a rectified linear unit (ReLU), a leaky ReLU, a parametric ReLU, an exponential LU function, a maxout function, swish, etc.

The normalization functionality component 306, 316 may be configured to control the input distribution across layers to speed up training and the improved accuracy of the outputs or activations. For example, the distribution of the inputs may be normalized to have a zero mean and a unit standard deviation. The normalization function may also use batch normalization (BN) techniques to further scale and shift the values for improved performance.

The pooling functionality components 308, 318 may be configured to reduce the dimensionality of a feature map generated by the convolution functionality component 302, 312 and/or otherwise allow the convolutional neural network 300 to resist small shifts and distortions in values.

In some embodiments, the inputs to the first layer 301 may be structured as a set of three-dimensional input feature maps 352 that form a channel of input feature maps. For example, the convolutional neural network 300 may include a batch size of N three-dimensional feature maps 352 with height H and width W each having C number of channels of input feature maps (illustrated as two-dimensional maps in C channels), and M three-dimensional filters 354 including C filters for each channel (also illustrated as two-dimensional filters for C channels). Applying the 1 to M filters 354 to the 1 to N three-dimensional feature maps 352 results in N output feature maps 356 that include M channels of width F and height E. As illustrated, each channel may be convolved with a three-dimensional filter 354. The results of these convolutions may be summed across all the channels to generate the output activations of the first layer 301 in the form of a channel of output feature maps 356. Additional three-dimensional filters may be applied to the input feature maps 352 to create additional output channels, and multiple input feature maps 352 may be processed together as a batch to improve the reuse of the filter weights. The results of the output channel (e.g., set of output feature maps 356) may be fed to the second layer 311 in the convolutional neural network 300 for further processing.

FIG. 4 is a component block diagram illustrating an example computing system implemented as a system in a package (SIP) 400 suitable for implementing various embodiments. With reference to FIGS. 1-4, various embodiments may be implemented in a variety of architectures that may be used in processing systems, including single processor, multiple processor, and multiprocessor processing systems, a system-on-chip (SOC), a SIP, and any combination thereof.

The SIP 400 may include a two SOCs 402, 404, a clock 406, and a voltage regulator 408. In some embodiments, the first SOC 402 may operate as central processing unit (CPU) of the computing device that carries out the instructions of software application programs by performing the arithmetic, logical, control and input/output (I/O) operations specified by the instructions. In some embodiments, the second SOC 404 may operate as a specialized processing unit. For example, the second SOC 404 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SOC 402 may include a digital signal processor (DSP) 410, a modem processor 412, a graphics processor 414, an application processor 416, one or more coprocessors 418 (e.g., vector co-processor) connected to one or more of the processors, memory 420, deep processing unit (DPU) 421, AI processor 422, system components and resources 424, an interconnection/bus module 426, one or more temperature sensors 430, a thermal management unit 432, and a thermal power envelope (TPE) component 434. The second SOC 404 may include a 5G modem processor 452, a power management unit 454, an interconnection/bus module 464, a plurality of mmWave transceivers 456, memory 458, and various additional processors 460, such as an applications processor, packet processor, etc.

Each processor 410, 412, 414, 416, 418, 421, 422, 452, 460 may include one or more cores, and each processor/core may perform operations independent of the other processors/cores. For example, the first SOC 402 may include a processor that executes a first type of operating system (e.g., FreeBSD, LINUX, OS X, etc.) and a processor that executes a second type of operating system (e.g., MICROSOFT WINDOWS 10). In addition, any or all of the processors 410, 412, 414, 416, 418, 421, 422, 452, 460 may be included as part of a processor cluster architecture (e.g., a synchronous processor cluster architecture, an asynchronous or heterogeneous processor cluster architecture, etc.).

The first and second SOC 402, 404 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 424 of the first SOC 402 may include power amplifiers, voltage regulators, oscillators, phase-locked loops, peripheral bridges, data controllers, memory controllers, system controllers, Access ports, timers, and other similar components used to support the processors and software clients running on a UE device. The system components and resources 424 may also include circuitry to interface with peripheral devices, such as cameras, electronic displays, wireless communication devices, external memory chips, etc.

The first and second SOC 402, 404 may communicate via interconnection/bus module 450. The various processors 410, 412, 414, 416, 418, may be interconnected to one or more memory elements 420, system components and resources 424 and a thermal management unit 432 via an interconnection/bus module 426. Similarly, the processor 452 may be interconnected to the power management unit 454, the mmWave transceivers 456, memory 458, and various additional processors 460 via the interconnection/bus module 464. The interconnection/bus module 426, 450, 464 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 402, 404 may further include an input/output module (not illustrated) for communicating with resources external to the SOC, such as a clock 406, a voltage regulator 408, screen sensor unit 415 and a wireless transceiver 466 (e.g., cellular wireless transceiver, Bluetooth transceiver, etc.). Resources external to the SOC (e.g., clock 406, voltage regulator 408, screen sensor unit 415, wireless transceiver 466) may be shared by two or more of the internal SOC processors/cores.

In some embodiments, any or all of the processors 410, 412, 414, 416, 418, 421, 422, 452, 460 may implement a CNN-based AI image processing system, a Bilinear-Bicubic image processing pipeline and/or a convolutional neural network super resolution (CNN SR) image processing pipeline. For example, in some embodiments, the GPU 414 and/or DPU 421 may implement a Bilinear-Bicubic pipeline and/or AI processor 422, GPU 414, and/or DSP 410 may implement a CNN SR pipeline.

In some embodiments, any or all of the processors 410, 412, 414, 416, 418, 421, 422, 452, 460 may be configured to work in conjunction with the screen sensor unit 415 to perform a zoom operation on a display of a computing device in accordance with the embodiments. For example, the screen sensor unit 415 may monitor end user's touch gestures to conditionally trigger a layer dynamic seamless zoom and corresponding sequential up-scaling animation frames in continuous varying up-scale step factors (1.0-1.01-1.02-1.03-xxxxx-1.99, 2.00, 2.01-xxxxx-3.0). The screen sensor unit 415 may detect a zoom user input on an image layer within the display presented on an electronic display of the computing device, and send the information to the GPU 414 and AI processor 422. The GPU 414 may receive the zoom user input, and use an interpolation scaling technique in a first image processing pipeline to adjust a displayed size of the image layer. In parallel, the AI processor 422 may use a super resolution technique in a second image processing pipeline to adjust the displayed size of the image layer. The AI processor 422, GPU 414 and/or another processor (e.g., applications processor 416) may upscale an output of the interpolation scaling technique on the first image processing pipeline with an output from the super resolution technique on the second image processing pipeline to generate an upscaled frame of the image layer, and cause an electronic display of a computing device to display the upscaled frame of the image layer.

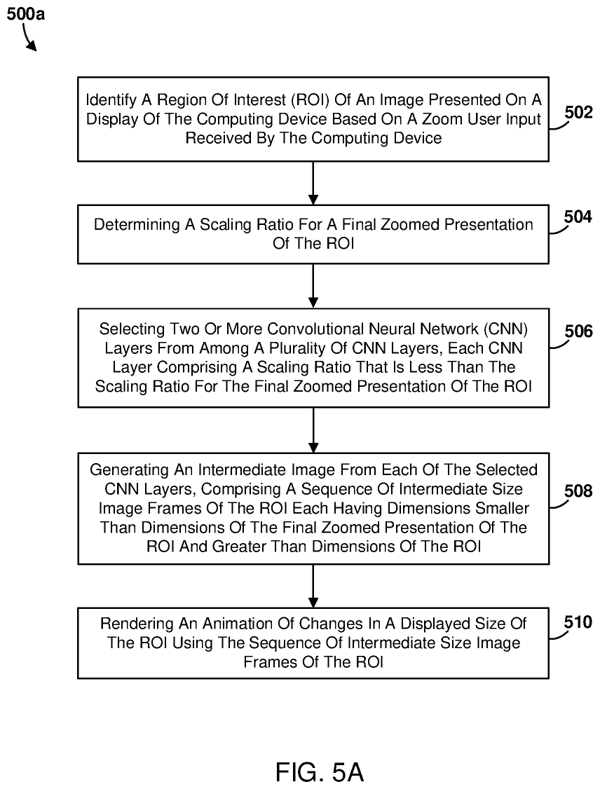

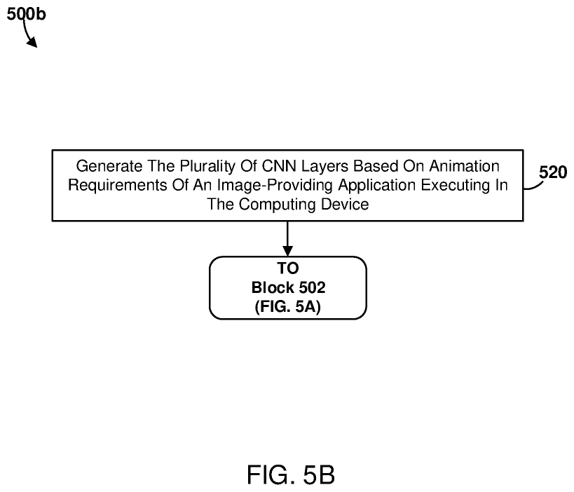

FIG. 5A illustrates a method 500a of performing a zoom operation on a computing device according to various embodiments. With reference to FIGS. 1-5A, means for performing operations of the method 500a may include a processing system as described herein. A processing system may include one or more processors (e.g., processors 410, 412, 414, 416, 418, 421, 422, 452, 460) in a computing device (e.g., 118, 400) and/or hardware elements, any one or combination of which may be configured to perform any of the operations of the method 500a. Further, one or more processors within a processing system may be configured with software or firmware to perform various operations of the method. To encompass any of the processor(s), hardware elements and software elements that may be involved in performing the method 500a, the elements performing method operations are referred to generally as a “processing system.”

In block 502, the processing system may identify an ROI of an image presented on a display of the computing device based on a zoom user input received by the computing device.

In block 504, the processing system may determine a scaling ratio for a final zoomed presentation of the ROI. The processing may determine the scaling ratio based on a number of factors known to the processor, such as but not limited to the initial dimensions of the ROI, dimensions of the computing device display, a ratio of the ROI dimensions to display dimensions, computing resources available for performing the scaling operations, estimated computing time required to perform scaling operations, and the like.

In block 506, the processing system may select two or more CNN layers from among a plurality of CNN layers. In some embodiments, each CNN layer may include a scaling ratio that is less than the scaling ratio for the final zoomed presentation of the ROI. In some embodiments, at least one of the selected CNN layers may include a non-integer scaling ratio. In some embodiments, the processing system may select the quantity of the plurality of CNN layers based on an application requirement of an application executing in the computing device that provided the image. In some embodiments, the processing system may select the quantity of the plurality of CNN layers based on an available quantity of memory of the computing device. In some embodiments, the processing system may select the quantity of the plurality of CNN layers based on the determined scaling ratio for the final zoomed presentation of the ROI.

In block 508, the processing system may generate an intermediate image from each of the selected CNN layers. The generated intermediate images may provide a sequence of intermediate size image frames of the ROI, with each image having dimensions smaller than dimensions of the final zoomed presentation of the ROI and greater than dimensions of the ROI.

In block 510, the processing system may render an animation of changes in the displayed size of the ROI using the sequence of intermediate size image frames of the ROI. Rending the animation may involve sequentially displaying ever larger images. In some embodiments, linear scaling techniques may be used by the processing system to enlarge intermediate size image frames to provide additional image frames in the animation sequence to further smooth out increases in ROI size from frame to frame.

FIG. 5B illustrates operations 500b that may be performed as part of the method 500a of performing a zoom operation on a computing device according to various embodiments. With reference to FIGS. 1-5B, means for performing operations 500b may include a processing system as described herein. A processing system may include one or more processors (e.g., processors 410, 412, 414, 416, 418, 421, 422, 452, 460) in a computing device (e.g., 118, 400) and/or hardware elements, any one or combination of which may be configured to perform any of the operations of the operations 500b. Further, one or more processors within a processing system may be configured with software or firmware to perform various operations of the method. To encompass any of the processor(s), hardware elements and software elements that may be involved in performing the operations 500b, the elements performing method operations are referred to generally as a “processing system.”

In block 520, the processing system may generate the plurality of CNN layers based on animation requirements of an image-providing application executing in the computing device.

The processing system may identify an ROI of an image presented on a display of the computing device based on a zoom user input received by the computing device in block 502 of the method 500a as described.

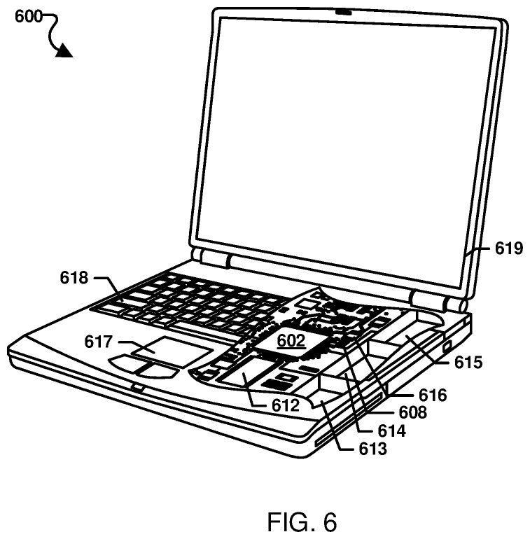

FIG. 6 is a component block diagram of a computing device suitable for use with various embodiments. With reference to FIGS. 1-6, in some embodiments, the computing device may be implemented in the form of a laptop computer 600. In various embodiments, the laptop computer 600 may include a touchpad (or trackpad) touch surface 617 that serves as the computer's pointing device, and thus may receive pinch in, pinch out, drag, scroll, flick gestures, etc. similar to those that may be implemented on computing devices equipped with a touch screen display. The laptop computer 600 may include a processing system 602 coupled to volatile memory 612 and a large capacity nonvolatile memory, such as a disk drive 613 of Flash memory. Additionally, the laptop computer 600 may include one or more antenna 608 for sending and receiving electromagnetic radiation that may be connected to a wireless data link and/or cellular telephone transceiver 616 coupled to the processing system 602. The laptop computer 600 may also include a transceiver 614 implementing short range wireless communication using a variety of short-range communication protocols, such as any of the Institute of Electrical and Electronics Engineers (IEEE) 802.11 and 802.15 protocols. The laptop computer 600 also may include a compact disc (CD) drive 615 coupled to the processing system 602. The laptop computer 600 may include a touchpad 617, a keyboard 618, and a display 619 all coupled to the processing system 602. Other configurations of the laptop computer 600 may include a computer mouse or trackball coupled to the processing system (e.g., via a Universal Serial Bus (USB) input) as are well known, which may also be used in conjunction with various embodiments.

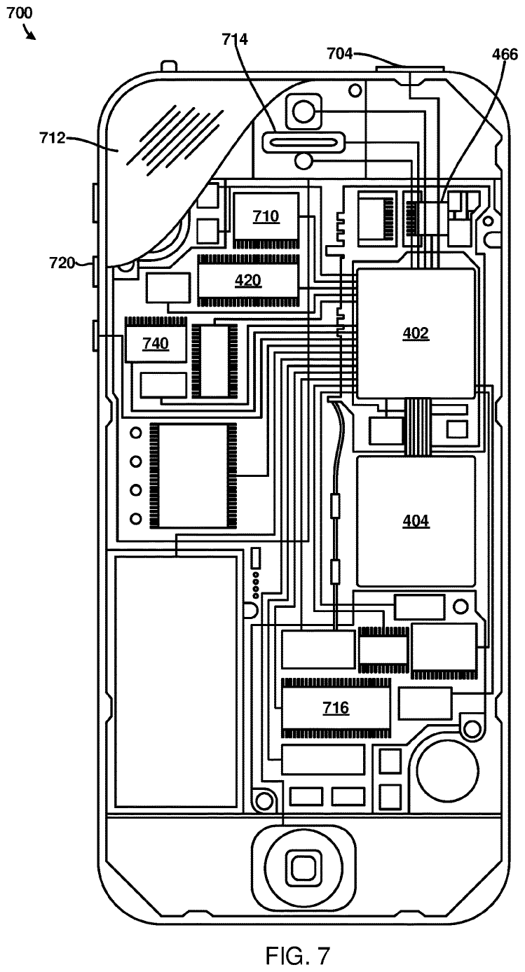

FIG. 7 is a component block diagram of a computing device suitable for use with various embodiments. With reference to FIGS. 1-7, in some embodiments, the computing device may be implemented in the form of a smartphone 700. The smartphone 700 may include a first circuitry 402 coupled to a second circuitry 404. The first and second SoCs 402, 404 may be coupled to internal memory 716, a display 712, and to a speaker 714. The display 712 may include or incorporate a touch sensitive input device configured to receive an input such as pinch in, pinch out, drag, scroll, flick gestures, etc. The first and second circuitries 402, 404 may also be coupled to at least one subscriber identity module (SIM) 740 and/or a SIM interface that may store information supporting a first 5GNR subscription and a second 5GNR subscription, which support service on a 5G non-standalone (NSA) network.

The smartphone 700 may include an antenna 704 for sending and receiving electromagnetic radiation that may be connected to a wireless transceiver 466 coupled to one or more processing systems in the first and/or second circuitries 402, 404. The smartphone 700 also may include menu selection buttons or rocker switches 720 for receiving user inputs. The smartphone 700 also may include a sound encoding/decoding (CODEC) circuit 710, which digitizes sound received from a microphone into data packets suitable for wireless transmission and decodes received sound data packets to generate analog signals that are provided to the speaker to generate sound. Also, one or more of the processing systems in the first and second circuitries 402, 404, wireless transceiver 466 and CODEC 710 may include a digital signal processor (DSP) circuit 740.

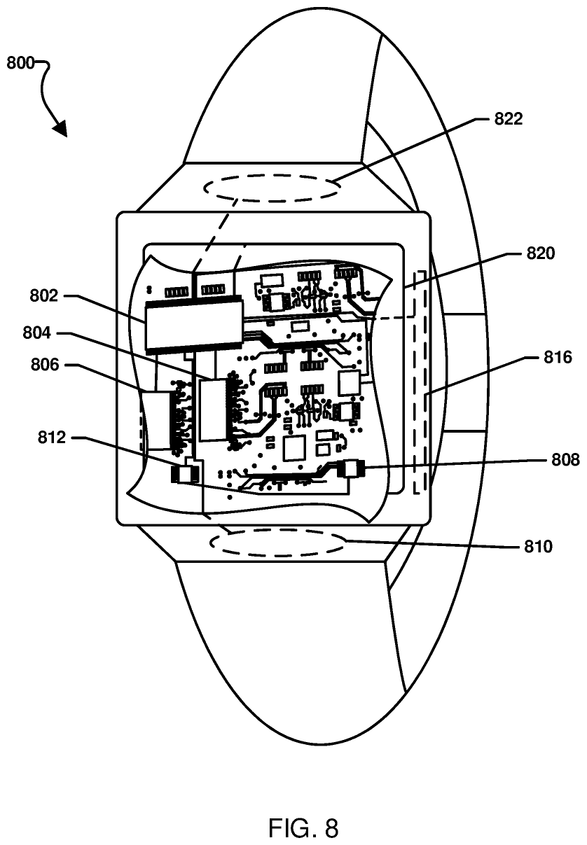

FIG. 8 is a component block diagram of a computing device suitable for use with various embodiments. With reference to FIGS. 1-8, in some embodiments, the computing device may be implemented in the form of a smart watch 800.

The smart watch 800 may include an SoC 802 including two or more processing systems (e.g., application processor, low power processor) coupled to internal memories 804 and 806. Internal memories 804, 806 may be volatile or nonvolatile memories, and may also be secure and/or encrypted memories, or unsecure and/or unencrypted memories, or any combination thereof. The SoC 802 may also be coupled to a touchscreen display 820, such as a resistive-sensing touchscreen, capacitive-sensing touchscreen infrared sensing touchscreen, or the like. Additionally, the smart watch 800 may have one or more antenna 808 for sending and receiving electromagnetic radiation that may be connected to one or more wireless data links 812, such as one or more Bluetooth® transceivers that may be coupled to the SoC 802.

The smart watch 800 may also include physical and/or virtual buttons 822 and 810 for receiving user inputs as well as a slide sensor 816 for receiving user inputs. The touchscreen display 820 may be coupled to a touchscreen interface module that is configured receive signals from the touchscreen display 820 indicative of locations on the screen where a user's fingertip or a stylus is touching the surface and output to the SoC 802 information regarding the coordinates of touch events. The physical and/or virtual buttons 822 and touchscreen display 820 may be configured to receive an input such as pinch in, pinch out, drag, scroll, flick gestures, etc. Further, the SoC 802 may be configured with processor-executable instructions to correlate images presented on the touchscreen display 820 with the location of touch events received from the touchscreen interface module in order to detect when a user has interacted with a graphical interface icon, such as a virtual button.

The SoC 802 may be any programmable microprocessor, microcomputer, multiple processor chip or processing systems that can be configured by software instructions (applications) to perform a variety of functions, including the functions of various embodiments. In some devices, multiple processing systems may be provided, such as one processing system dedicated to wireless communication functions and one processing system dedicated to running other applications. Typically, software applications may be stored in an internal memory before they are accessed and loaded into the SoC 802. The SoC 802 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 802 including internal memory or removable memory plugged into the wearable device and memory within the SoC 802 itself.

The processing systems of the laptop computer 600, the smart phone 700, and the smart watch 800 may be any programmable microprocessor, microcomputer, multiple processor chip or processing systems that can be configured by software instructions (applications) to perform a variety of functions, including the functions of various embodiments described. In some computing devices, multiple processors may be provided, such as one processing system within first circuitry dedicated to wireless communication functions and one processing system within second circuitry dedicated to running other applications. Software applications may be stored in the memory before they are accessed and loaded into the processing system. The processing systems may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processing system configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processing system of a computing device to perform the operations of the methods of the following implementation examples.
Example 1. A method of performing a zoom operation on a computing device, including, identifying a region of interest (ROI) of an image presented on a display of the computing device based on a zoom user input received by the computing device, determining a scaling ratio for a final zoomed presentation of the ROI, selecting two or more convolutional neural network (CNN) layers from among a plurality of CNN layers, each CNN layer including a scaling ratio that is less than the scaling ratio for the final zoomed presentation of the ROI, generating an intermediate image from each of the selected CNN layers, including a sequence of intermediate size image frames of the ROI each having dimensions smaller than dimensions of the final zoomed presentation of the ROI and greater than dimensions of the ROI, and rendering an animation of changes in a displayed size of the ROI using the sequence of intermediate size image frames of the ROI.
Example 2. The method of example 1, in which at least one of the selected CNN layers includes a non-integer scaling ratio.
Example 3. The method of either of examples 1 and 2, in which selecting two or more CNN layers from among the plurality of CNN layers includes selecting a quantity of the plurality of CNN layers based on an application requirement of an application executing in the computing device that provided the image.
Example 4. The method of any of examples 1-3, in which selecting two or more CNN layers from among the plurality of CNN layers includes selecting a quantity of the plurality of CNN layers based on an available quantity of memory of the computing device.
Example 5. The method of any of examples 1-4, further including generating the plurality of CNN layers based on animation requirements of an image-providing application executing in the computing device.
Example 6. The method of example 5, in which at least one of the generated plurality of CNN layers includes a non-integer scaling ratio.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processing system, an object, an executable, a thread of execution, a program, and/or a computer. By way of illustration, both an application running on a computing device and the computing device may be referred to as a component. One or more components may reside within a process and/or thread of execution and a component may be localized within a processing system on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processing system may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of performing a zoom operation on a computing device, comprising:
identifying a region of interest (ROI) of an image presented on a display of the computing device based on a zoom user input received by the computing device;
determining a scaling ratio for a final zoomed presentation of the ROI;
selecting two or more convolutional neural network (CNN) layers from among a plurality of CNN layers, each CNN layer comprising a scaling ratio that is less than the scaling ratio for the final zoomed presentation of the ROI;
generating an intermediate image from each of the selected CNN layers, comprising a sequence of intermediate size image frames of the ROI each having dimensions smaller than dimensions of the final zoomed presentation of the ROI and greater than dimensions of the ROI; and
rendering an animation of changes in a displayed size of the ROI using the sequence of intermediate size image frames of the ROI.

2. The method of claim 1, wherein at least one of the selected CNN layers includes a non-integer scaling ratio.

3. The method of claim 1, wherein selecting two or more CNN layers from among the plurality of CNN layers comprises selecting a quantity of the plurality of CNN layers based on an application requirement of an application executing in the computing device that provided the image.

4. The method of claim 1, wherein selecting two or more CNN layers from among the plurality of CNN layers comprises selecting a quantity of the plurality of CNN layers based on an available quantity of memory of the computing device.

5. The method of claim 1, further comprising generating the plurality of CNN layers based on animation requirements of an image-providing application executing in the computing device.

6. The method of claim 5, wherein at least one of the generated plurality of CNN layers includes a non-integer scaling ratio.

7. A computing device, comprising:
a processing system configured to:
identify a region of interest (ROI) of an image presented on a display of the computing device based on a zoom user input received by the computing device;
determine a scaling ratio for a final zoomed presentation of the ROI;
select two or more convolutional neural network (CNN) layers from among a plurality of CNN layers, each CNN layer comprising a scaling ratio that is less than the scaling ratio for the final zoomed presentation of the ROI;
generate an intermediate image from each of the selected CNN layers, comprising a sequence of intermediate size image frames of the ROI each having dimensions smaller than dimensions of the final zoomed presentation of the ROI and greater than dimensions of the ROI; and
render an animation of changes in a displayed size of the ROI using the sequence of intermediate size image frames of the ROI.

8. The computing device of claim 7, wherein at least one of the selected CNN layers includes a non-integer scaling ratio.

9. The computing device of claim 7, wherein the processing system is further configured to select a quantity of the plurality of CNN layers based on an application requirement of an application executing in the computing device that provided the image.

10. The computing device of claim 7, wherein the processing system is further configured to select a quantity of the plurality of CNN layers based on an available quantity of memory of the computing device.

11. The computing device of claim 7, wherein the processing system is further configured to generate the plurality of CNN layers based on animation requirements of an image-providing application executing in the computing device.

12. The computing device of claim 11, wherein the processing system is further configured such that at least one of the generated plurality of CNN layers includes a non-integer scaling ratio.

13. A computing device, comprising:
means for identifying a region of interest (ROI) of an image presented on a display of the computing device based on a zoom user input received by the computing device;
means for determining a scaling ratio for a final zoomed presentation of the ROI;
means for selecting two or more convolutional neural network (CNN) layers from among a plurality of CNN layers, each CNN layer comprising a scaling ratio that is less than the scaling ratio for the final zoomed presentation of the ROI;
means for generating an intermediate image from each of the selected CNN layers, comprising a sequence of intermediate size image frames of the ROI each having dimensions smaller than dimensions of the final zoomed presentation of the ROI and greater than dimensions of the ROI; and
means for rendering an animation of changes in a displayed size of the ROI using the sequence of intermediate size image frames of the ROI.

14. The computing device of claim 13, wherein at least one of the selected CNN layers includes a non-integer scaling ratio.

15. The computing device of claim 13, wherein means for selecting two or more CNN layers from among the plurality of CNN layers comprises means for selecting a quantity of the plurality of CNN layers based on an application requirement of an application executing in the computing device that provided the image.

16. The computing device of claim 13, wherein means for selecting two or more CNN layers from among the plurality of CNN layers comprises means for selecting a quantity of the plurality of CNN layers based on an available quantity of memory of the computing device.

17. The computing device of claim 13, further comprising means for generating the plurality of CNN layers based on animation requirements of an image-providing application executing in the computing device.

18. The computing device of claim 17, wherein at least one of the generated plurality of CNN layers includes a non-integer scaling ratio.

19. (canceled)

20. (canceled)

21. (canceled)

22. (canceled)

23. (canceled)

24. (canceled)
